(19) United States
(12) Patent Application Publication
(10) Pub. No.: US 2019/0265489 A1
(43) Pub. Date: Aug. 29, 2019

(54) LASER PROCESSING SYSTEM WITH MODIFIED BEAM ENERGY DISTRIBUTION

(71) Applicant: Universal Laser Systems, Inc., Scottsdale, AZ (US)

(72) Inventors: Yefim P. Sukhman, Scottsdale, AZ (US); David T. Richter, Scottsdale, AZ (US); Christian J. Risser, Scottsdale, AZ (US); Stefano J. Noto, Mesa, AZ (US); Mikhail E. Ryskin, Phoenix, AZ (US)

(21) Appl. No.: 16/412,803

(22) Filed: May 15, 2019

Related U.S. Application Data
(62) Division of application No. 15/366,381, filed on Dec. 1, 2016.
(60) Provisional application No. 62/301,469, filed on Feb. 29, 2016.

(51) Int. Cl. G02B 27/09; B23K 26/06; B23K 26/064; G02B 27/10; B23K 26/073; G02B 27/28

(52) U.S. Cl. CPC G02B 27/0927; B23K 26/0648; B23K 26/064; B23K 26/0626; B23K 26/0643; H01S 3/0071; B23K 26/073; B23K 26/0608; G02B 27/283; G02B 27/1006; G02B 27/106

(57) ABSTRACT

Systems and methods for laser processing using a modified laser beam having a non-Gaussian energy distribution are described herein. In some embodiments, a laser processing system includes a laser source that outputs a laser beam having a Gaussian energy distribution, and a beam modifier positioned in a path of the output beam. The beam modifier controllably modifies the Gaussian energy distribution of the output laser beam along at least one axis perpendicular to the beam's axis of travel. In various embodiments, the laser processing system includes a beam delivery sub-subsystem that operates in a raster mode. In such embodiments, the subsystem can raster the modified beam across a material to form raster lines for transferring an image or pattern to the material.

### CROSS-REFERENCE TO RELATED APPLICATION(S)

This application claims the benefit of pending U.S. Provisional Patent Application No. 62/301,469, filed Feb. 29, 2016, which is incorporated herein by reference in its entirety.

### TECHNICAL FIELD

The present disclosure is directed generally to laser processing systems and, more specifically, to modifying energy distribution of laser beams used in laser processing systems.

### BACKGROUND

Lasers have a variety of industrial uses, including material processing. For example, a laser can cut shapes out of materials, remove or modify surface layers of materials, and weld or sinter materials. Laser material processing systems can employ several components including a laser energy source, optical elements and beam delivery motion system configured to direct laser energy to desired locations on a material to be laser processed, and an enclosure to contain stray laser energy and capture any exhaust contaminants.

### BRIEF DESCRIPTION OF THE DRAWINGS

FIG. 1 is a partially schematic, isometric view illustrating a laser processing system configured in accordance with an embodiment of the present technology.

FIGS. 2A-2C are isometric views illustrating a beam modifier of the laser processing system of FIG. 1.

FIG. 3 is a graph illustrating Gaussian energy distributions of a laser beam in a raster direction and a direction orthogonal to the raster direction.

FIG. 4 is a graph illustrating Gaussian and non-Gaussian energy distributions of a laser beam in a raster direction and an orthogonal direction, respectively.

FIGS. 5A-5D are various cross-sectional views of raster lines formed in a material using a modified laser beam in accordance with embodiments of the present technology.

FIG. 6 is a partially schematic, isometric view illustrating a laser processing system configured in accordance with another embodiment of the present technology.

FIG. 7 is a cross-sectional view of a combined beam modifier and a combined beam separator of the laser processing system of FIG. 6.

FIGS. 8A and 8B are cross-sectional views of focusing optics of the laser processing system of FIG. 6.

### DETAILED DESCRIPTION

The following disclosure describes systems and methods for laser processing using a modified laser beam having a non-Gaussian energy distribution. In some embodiments, a laser processing system includes a laser source that outputs a laser beam having a Gaussian energy distribution, and a beam modifier positioned in a path of the output beam. In various embodiments, the laser processing system includes a beam delivery subsystem that operates in a raster mode. The beam modifier modifies the Gaussian energy distribution of the output laser beam along at least one axis perpendicular to the raster travel direction of the beam delivery subsystem. In such embodiments, the subsystem can raster the modified beam across a material to mark or ablate raster lines into the material for transferring an image or pattern to the material.

In some embodiments, the modified laser beam can retain a substantially Gaussian energy distribution in a direction that is parallel to the raster direction, while the non-Gaussian energy distribution defines a width of a raster line in a direction that is orthogonal to the raster direction. The raster line can be wider than a raster line formed with a laser beam having a traditional energy distribution (e.g., a Gaussian energy distribution in the orthogonal direction). In some embodiments, the width of the raster line can be dynamically adjusted via the beam modifier. Widening the beam, for example, can increase throughput, while narrowing the beam can increase resolution of an image or pattern defined by a set of raster lines. In some embodiments, the laser processing system includes multiple lasers and a beam combiner operably coupled to one or more beam modifiers to produce multiple parallel raster lines in one raster stroke. The parallel raster lines can further increase throughput. In various embodiments described below, the separation distance between the parallel lines and the width of one or both of the raster lines can be dynamically adjusted.

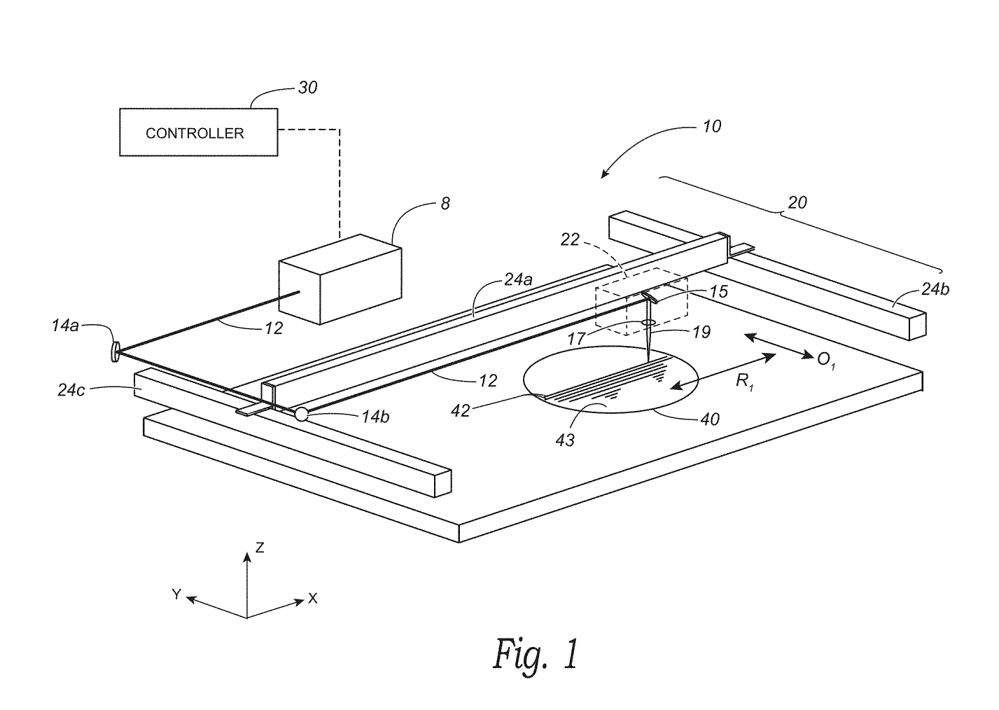

FIG. 1 is a partially schematic, isometric view illustrating a laser processing system 10 configured in accordance with embodiments of the present technology. The laser processing system 10 includes a beam delivery subsystem 20 operably coupled to a laser source 8. The laser source 8 outputs a laser beam 12 over a beam path defined by optical elements 14a and 14b (collectively beam positioning optics 14). The beam delivery subsystem 20 can include, for example, a carriage assembly 22 (shown in hidden lines) moveably coupled to a first guide member 24a, such as a support beam. The first guide member 24a, in turn, can be moveably coupled to second and third guide members 24b and 24c (e.g., a pair of guide rails). The carriage assembly 22 and the guide members 24 can be operably coupled to one or more motors (not shown) controlled by a controller 30 (shown schematically).

As further shown in FIG. 1, the laser processing system 10 includes a laser beam modifier 15 (“beam modifier 15”) and focusing optics 17 optically coupled to the beam modifier 15. In the illustrated embodiment, the beam modifier 15 and the focusing optics 17 are carried by the carriage assembly 22. In other embodiments, the beam modifier 15 and/or the focusing optics 17 can be positioned differently within a laser processing system. For example, in some embodiments, the beam modifier 15 can be positioned in the path of the laser beam 12 between the laser source 8 and the optical element 14a. In other embodiments, the beam modifier 15 can be incorporated into the positioning optics 14.

Each of the beam modifier 15 and the focusing optics 17 can include one or more optical elements, such as reflective and refractive elements. The term “optical element” can be used to refer to any of a variety of optical elements, such as a lens, mirror, a grating structure, or other component (e.g., optical, electrical, and/or mechanical) configured to guide and/or modify a laser beam. For example, an optical element can include a material with a dichroic or multichroic coating for selectively reflecting and/or transmitting certain wavelengths. In the embodiment illustrated in FIG. 1, the focusing optics 17 include a refractive element. In other embodiments, the focusing elements can include a reflective element in addition to or in lieu of the refractive element.

In operation, the beam delivery subsystem 20 guides the output laser beam 12 via the optical elements 14, the carriage assembly 22, and the guide members 24 along a beam delivery path to the beam modifier 15. The beam modifier 15 modifies an energy distribution of the laser beam 12, and the focusing optics 17 concentrate energy of a modified laser beam 19, as described below. The focusing optics 17 output the modified laser beam 19 on or in a close proximity to a surface 43 of a material 40 being processed.

In various embodiments, the laser processing system 10 operates in a raster mode in which it produces a series of impressions, such as raster lines 42, in the material 40 corresponding to a desired pattern (e.g., an image) to be transferred. The pattern can be broken up into dots of a certain resolution (e.g., 500 dots/inch). The pattern is then recreated on the material 40 by passing the modified laser beam 19 back and forth over the material 40 in one or more first directions (e.g., a forward and/or reverse raster direction R₁), and stepping in small increments (e.g., 0.001 inch/line) in a second direction (e.g., orthogonal direction O₁) that is generally perpendicular to the raster direction R₁. The modified laser beam 19 engraves or marks a line of dots in the material 40 with each pass in accordance with the pattern. In various embodiments, the controller 30 can store a program or “information” that dictates the location and size (e.g., the line width/resolution) of the various raster lines used to construct the transferred pattern.

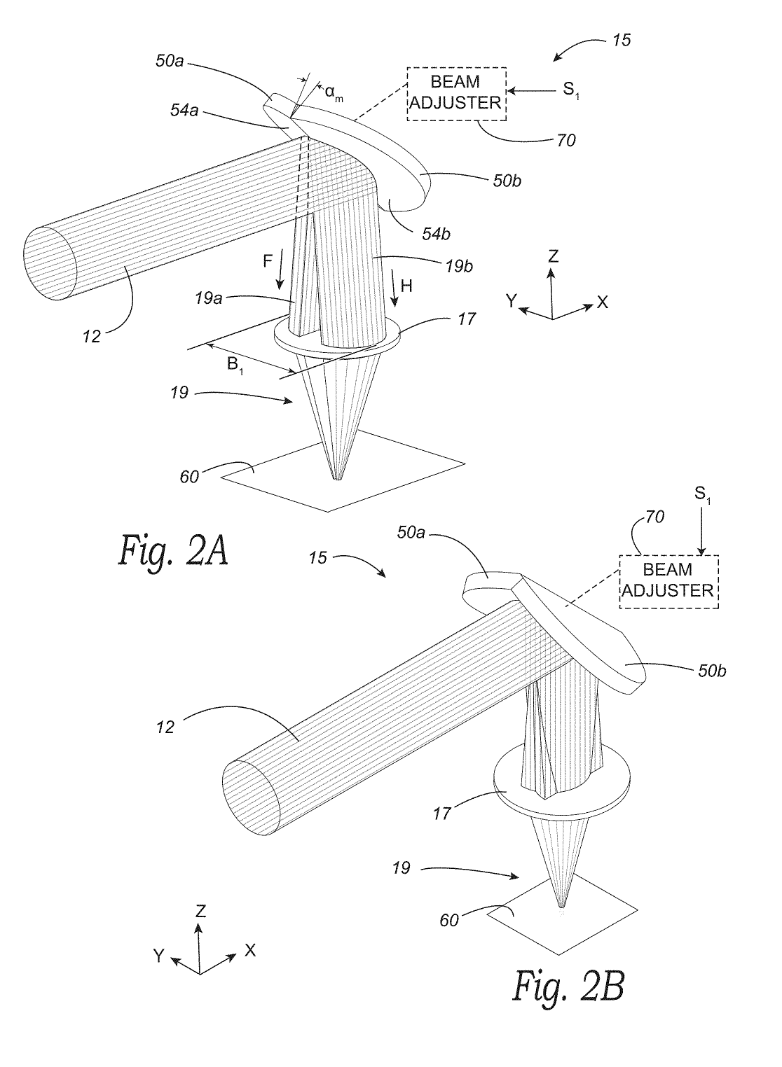

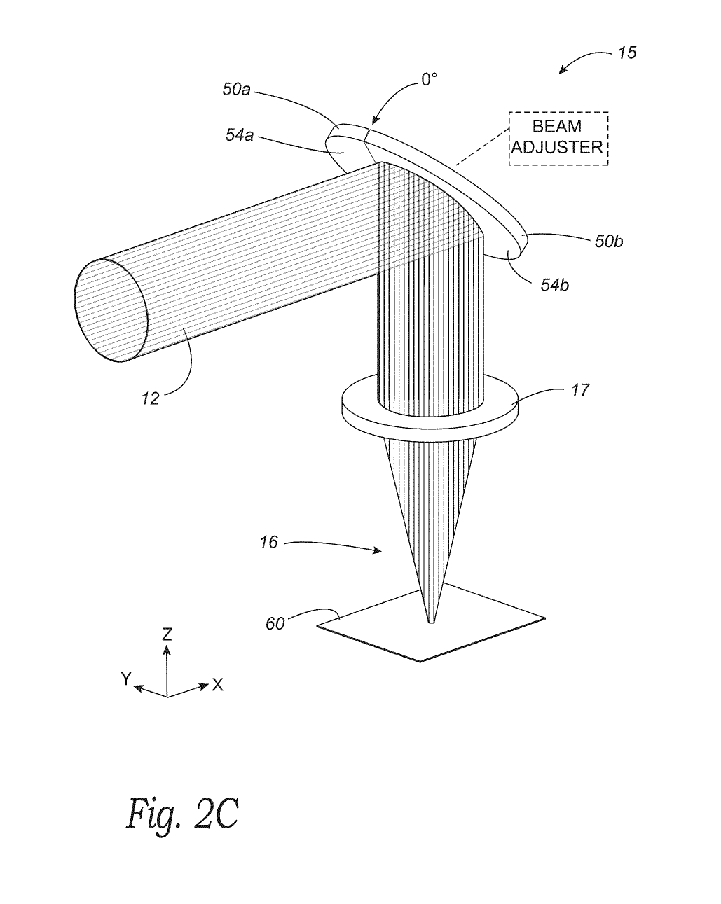

FIG. 2A is an isometric view showing the beam modifier 15 modifying the laser beam 12, and the focusing optics 17 outputting the modified beam 19. In the illustrated embodiment, the beam modifier 15 includes a first reflective element 50a having a first reflective surface 54a, and a second reflective element 50b having a second reflective surface 54b adjacent the first reflective surface 54a. The second reflective surface 54b is angled at a beam modification angle αₘ relative to the first reflective surface 54a. The beam modification angle αₘ can be a relatively shallow angle in a range of, e.g., about 0° to about 0.25°. An angle of 0°, as shown in FIG. 2C, equates to an unmodified beam 16. As the angle is changed from 0°, the amount of modification increases, allowing the desired amount of beam modification to be selected.

Each of the reflective surfaces 54 includes a reflective region that extends into a beam path of the laser beam 12 received by the beam modifier 15. Referring back to FIG. 2A, the reflective region of the first reflective surface 54a reflects a first beam portion 19a toward the focusing optics 17 in a first direction, as shown by arrow F. The reflective region of the second reflective surface 54b reflects a second beam portion 19b toward the focusing optics 17 in a second direction, as shown by arrow H. In this way, a slight angle is introduced between beam portions 19a and 19b, corresponding to the tilt of the beam modification angle αₘ. For example, a larger beam modification angle αₘ will increase a beam spread amount B₁ (e.g., a distance) over which the beam portions are spread across a surface of the focusing optics 17, while a smaller beam modification angle αₘ will decrease the beam spread amount B₁.

The focusing optics 17 receive the reflected beam portions 19a and 19b and focus them to concentrate the energy of the modified laser beam 19 at a focal plane 60 or at a different plane (not shown). The modified laser beam 19 has an energy distribution that is modified based on the angle between portions 19a and 19b. In various embodiments, the modified laser beam 19 is not spread in the raster direction R₁ (FIG. 1). In some embodiments, the beam modifier 15 can include one or more beam adjuster components 70 (e.g., a piezoelectric device, a servo motor, etc.; shown schematically) operably coupled to one or of both of the reflective elements 50. The beam adjuster components 70 can receive a beam adjustment signal S₁ from a controller, such as the controller 30 (FIG. 1). The beam adjuster components 70 can be configured to change the relative orientation (e.g., the beam modification angle αₘ) of the reflective elements 50 based on the beam adjustment signal S₁. In some embodiments described below, the beam adjuster components 70 can controllably transform the input laser beam 12 into a substantially non-Gaussian beam, such a substantially Gaussian beam that preserves a Gaussian distribution in a direction (e.g., the raster direction R₁) perpendicular to a direction of a non-Gaussian transformation (e.g., a non-Gaussian transformation along the orthogonal direction O₁).

In various embodiments, the beam adjuster components 70 can dynamically adjust the beam modification angle αₘ from the angle shown in FIG. 2A to a different positive angle greater than 0°. The adjustment can change the spread of the laser beam in the orthogonal direction O₁. In other embodiments, the beam adjustor components 70 can adjust the beam modification angle αₘ to an angle that is less than 0°, an angle in a range of about 0° to about −0.25°), as shown in FIG. 2B. In such embodiments, the beam portions 19a and 19b overlap and spread across the surface of the focusing optics 17 in a direction opposite to that shown in FIG. 2A. In some embodiments, the spread of the overlapping beam portions 19a and 19b can change the energy distribution in a manner similar to the diverging beams 19a and 19b shown in FIG. 2A. In these and other embodiments, the beam modification angle can be dynamically adjusted to 0°. In such a case, the focusing optics 17 output the laser beam 19 without substantial or any modification due to the zero angle between the reflective elements 50.

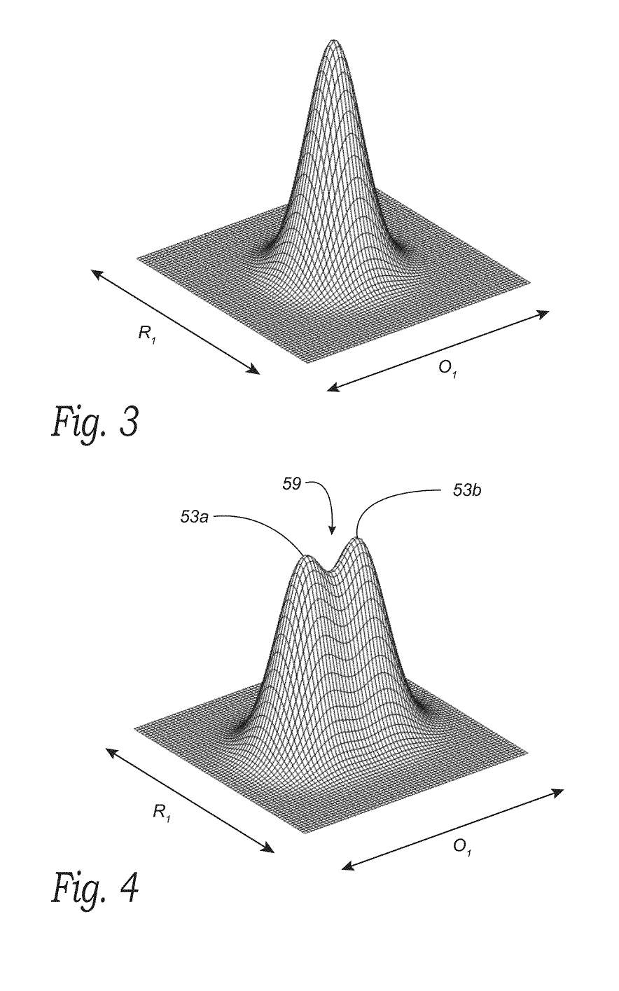

FIG. 3 is a graph showing energy distribution of the laser beam 12 (FIG. 1) before modification by the beam modifier 15 in FIG. 2A, such as before the laser beam 12 is incident the beam modifier 15, or when the beam adjustment angle αₘ is zero (FIG. 2B). In the illustrated embodiment, the laser beam 12 has a power profile with Gaussian energy distribution in both the raster and the orthogonal directions direction R₁ and O₁, respectively. In various implementations the shape of a Gaussian energy distribution may deviate from the theoretical values of a Gaussian function. The term “Gaussian” can be used to generally refer to energy profiles having a substantially higher energy density towards the center of the beam. Such Gaussian energy profiles may exhibit characteristics that are similar to conventional laser beam energy profiles configured to have a generally Gaussian shape. In general, Gaussian energy profiles can maximize power density of a laser beam. This, in turn, reduces the spot size of the laser beam when focused and increases the overlap required between raster lines in order to accurately transfer the pattern to the material 40 (FIG. 1).

FIG. 4 is a graph showing energy distribution of the modified laser beam 19 (FIG. 1) modified by the beam modifier 15 in FIG. 2A. Referring to FIG. 4, the modified laser beam has a Gaussian energy distribution in the raster direction R₁. In some embodiments, the Gaussian energy distribution can be the same as or substantially similar to the Gaussian distribution in the raster direction R₁ shown in FIG. 3.

As further shown in FIG. 4, the modified laser beam 19 has a non-Gaussian energy distribution in the orthogonal direction O₁ (FIG. 1). In various embodiments, the shape of the non-Gaussian energy distribution can be dictated by energy distributions 53a and 53b of the reflected beam portions 19a and 19b (FIG. 2A), respectively. The focusing optics 17 (FIG. 2A) can constructively combine and concentrate the energy of the reflected beam portions 19a and 19b to spread the energy distribution of the modified laser beam into a non-Gaussian distribution in the orthogonal direction O₁. In general, the term “non-Gaussian energy distribution” can be used to refer to energy distributions that are substantially non-Gaussian and/or include a substantially non-Gaussian distribution along at least one axis of the modified laser beam (e.g., along the orthogonal direction O₁ but not the raster direction R₁). Non-Gaussian distributions can include energy distributions having a profile 59 (e.g., a saddle region) that is substantially non-Gaussian in shape. In various embodiments, non-Gaussian distributions can include, for example, distributions having (1) substantially the same power level across the beam (e.g., a top-hat profile), (2) a relatively lower power level in the central region of the beam (e.g., a disc profile), or (3) a beam profile having a relatively sharp transition at an outer perimeter of the beam compared to a Gaussian beam profile. In some embodiments, a non-Gaussian power profile may be asymmetric and/or have local maxima and minima, such as when the laser beam 12 received by the beam modifier 15 is not evenly distributed across the reflective surfaces 54 (FIG. 2A) and a greater portion of the beam is incident on one of the reflective surfaces.

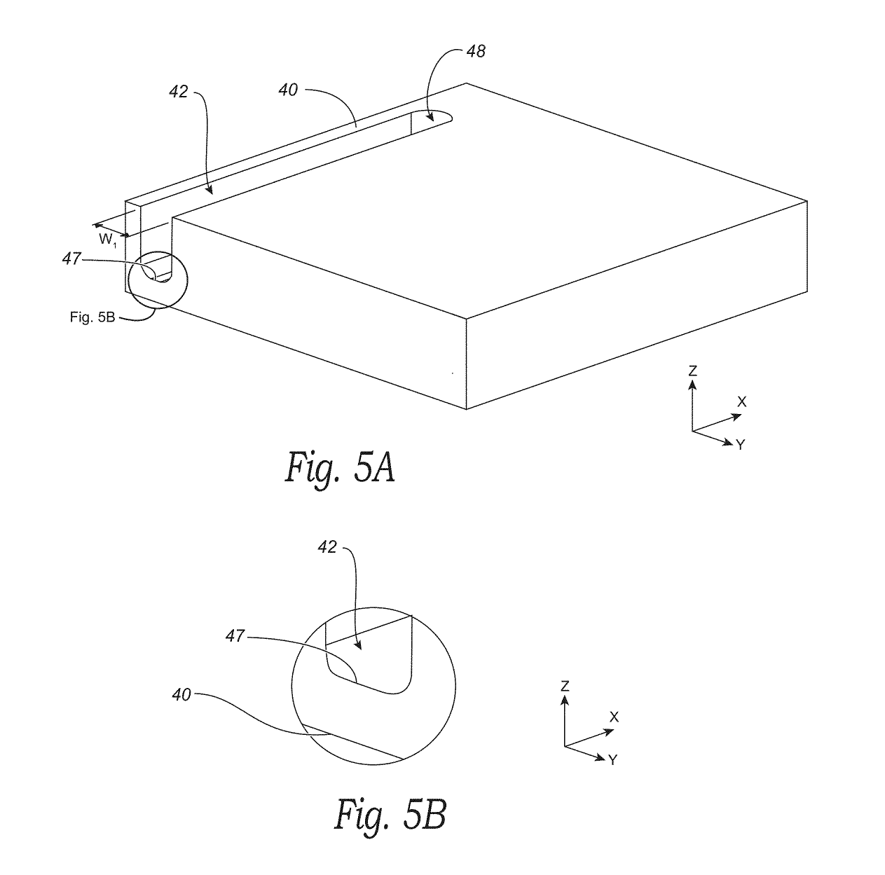

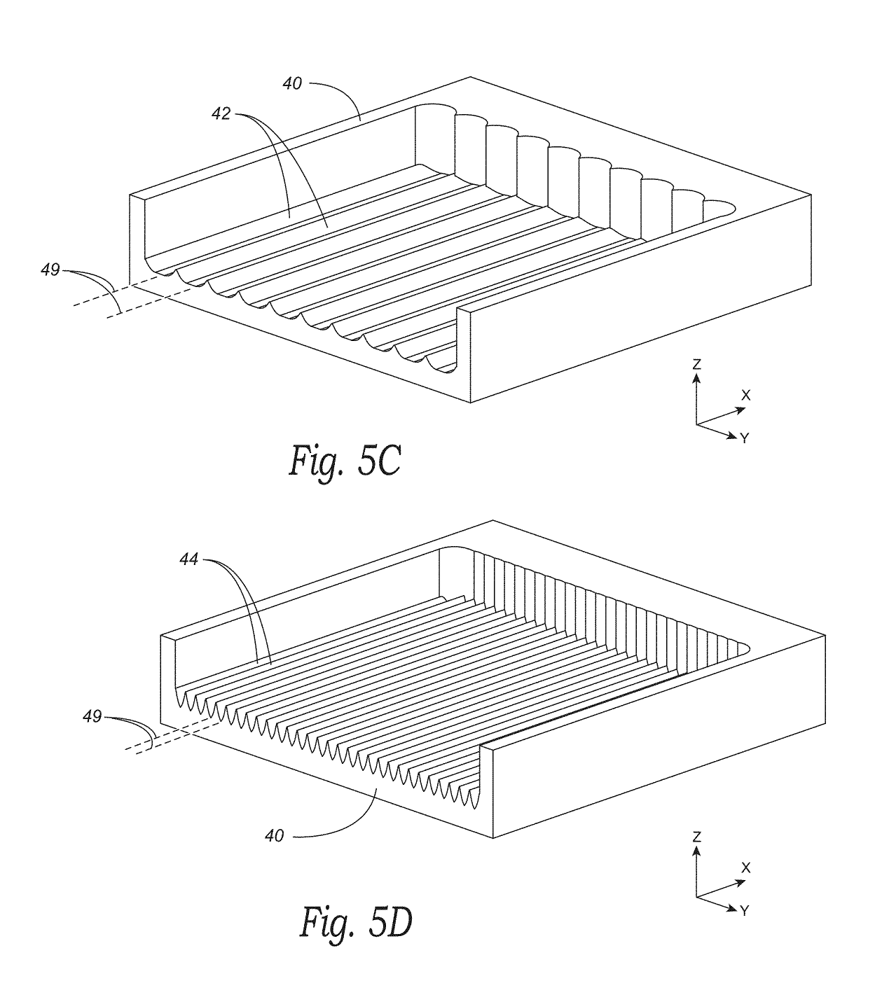

FIG. 5A is an enlarged view showing an individual raster line 42 marked or engraved into the material 40 before forming the other raster lines 42 shown in FIG. 1. The raster line tapers at an endpoint 48 and has a width W₁ and a shape along the width W₁ that corresponds to the non-Gaussian energy distribution of the laser beam 19 (FIG. 1) in the orthogonal direction O₁. For example, the raster line 42 can have a substantially uniform profile, including a relatively flat base region 47, as shown in FIG. 5B, corresponding to the non-Gaussian portion (e.g., the profile 59; FIG. 4B) of the energy distribution in the orthogonal direction O₁. The end point 48 (FIG. 5A) of the raster line 42, however, tapers due to the Gaussian energy distribution in the raster direction R₁. A Gaussian energy distribution can produce a deep but narrow imprint, while a non-Gaussian energy distribution can produce a wide and shallow imprint. A wider impression line width W₁ in the orthogonal direction O₁ can increase the width of material removed during each pass of a raster line. In general, increasing the magnitude of the beam adjustment angle αₘ of the beam adjuster 15 (FIGS. 2A and 2B) can increase the line width and its uniformity across the base 47, while decreasing the angle can generally decrease the line width and its uniformity.

FIG. 5C shows multiple raster lines 42 imprinted into the material 40 and overlapping one another. For example, each of the raster lines 42 includes a corresponding center line 49 that is spaced apart from the center line 49 of an adjacent raster line by a separation distance that is less than the width W₁ (FIG. 5A) associated with at least one of the adjacent raster lines. The amount of overlap can be selected based on a variety of factors, such as the amount of power incident on the material surface, the speed of the beam delivery subsystem 20 (FIG. 1), the rate of energy delivery of the laser source 8 (FIG. 1), and the chemical makeup of the gasses surrounding the processing point. A more uniform energy distribution can reduce the amount of overlap required between each successive raster line. Accordingly, the non-Gaussian energy distribution of the modified laser beam 19 can increases processing speed and throughput by widening the raster lines 42 and/or reducing the amount of overlap required between successive raster lines. In some instances, increasing the beam width can reduce the resolution of the transferred pattern in the orthogonal direction O₁. In various embodiments, the size of the line width can be selected via the beam modifier 15 (FIG. 1) based on the desired throughput and the degree of pattern or image resolution. For example, there may be a tradeoff between productivity of the laser system and quality of the pattern that is reproduced.

In some embodiments, the widths of the raster lines 42 can be maximum widths for maximizing an amount of information transfer for a given material. In such embodiments, the individual raster lines can be spaced apart from one another to transfer a maximum amount of information with a minimum number of lines. In other embodiments, the center lines 49 of the adjacent raster lines can be spaced apart by more than the width W₁ associated with at least one of the adjacent raster lines.

FIG. 5D shows a plurality of impressions, such as raster lines 44, that are formed by the laser processing system 10. The raster lines 44 are narrower than the raster lines 42 shown in FIG. 5C. The raster lines 44 can be narrowed relative to the raster lines 42 by reducing the magnitude of the beam modification angle αₘ. Each of the raster lines 44 can have more closely spaced center lines 49 and a width that is reduced relative to the width W₁ (FIG. 5A) of the individual raster lines 42. Similar to the beam used to form the raster lines 42, the modified beam used to form the raster lines 44 can be modified in the orthogonal direction O₁, but not substantially modified in the raster direction

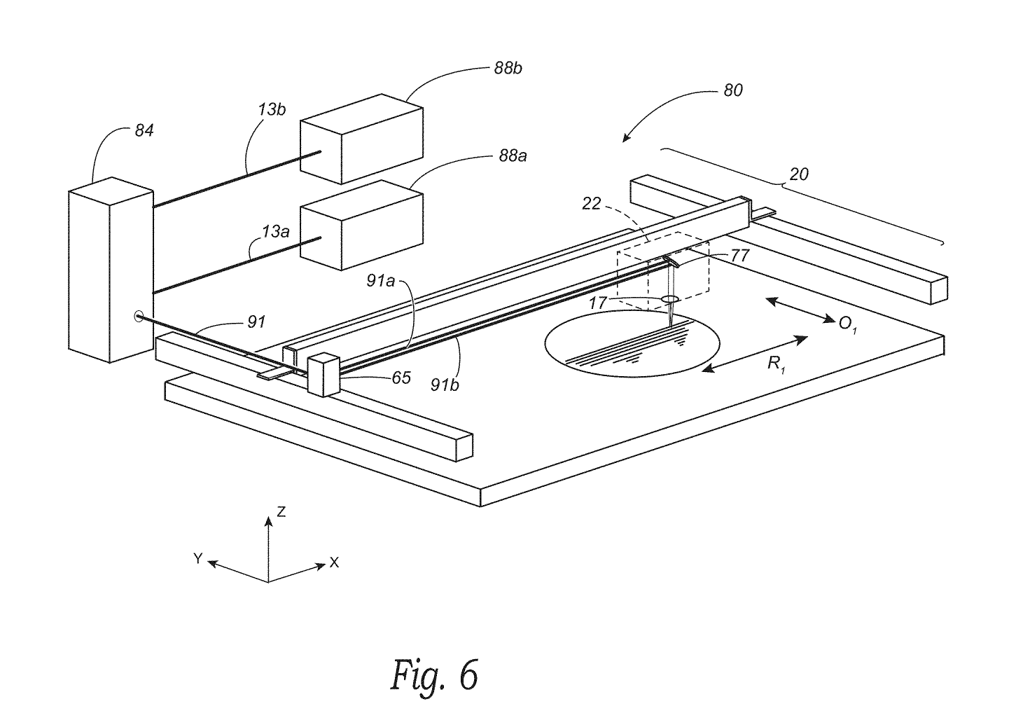

FIG. 6 is a partially schematic, isometric view illustrating a laser processing system 80 configured in accordance with another embodiment of the present technology. The laser processing system 80 can include features generally similar to features of the processing system 10 described above. For example, the laser processing system 80 includes the beam delivery subsystem 20, the carriage assembly 22 carrying the focusing optics 17, and a first laser source 88a. The laser processing system 80 further includes a second laser source 88b separately mounted from the first laser source 88a, and a combined beam modifier and a combined beam separator assembly 65 (collectively “beam modifier/separator 65”; shown schematically) positioned between the beam combiner 84 and the focusing optics 17. The beam combiner 84 combines the laser beams 13a and 13b into a combined laser beam 91 composed of collinear laser beams that are received by the beam modifier/separator 65, as described below. The beam modifier/separator 65 outputs a first modified beam 91a and a second modified beam 91b that are received by an optical element 77 (e.g., a reflective element) carried by the carriage assembly 22. The optical element 77 directs the modified beams 91a and 91b toward the focusing optics 17. In the example illustrated in FIG. 6, the optical element 77 can replace the beam modifier 15 held by the carriage 22 in the system 10 described above with reference to FIG. 1.

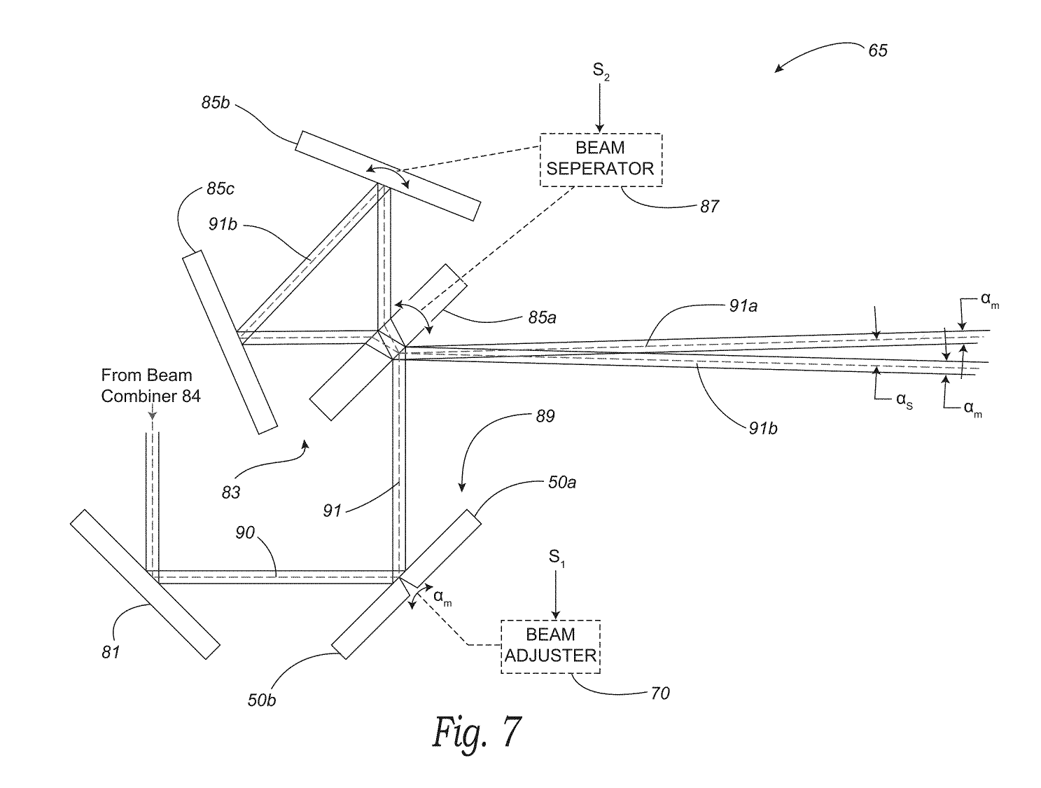

FIG. 7 is a cross-sectional view showing the beam modifier/separator 65 in further detail. The beam modifier/separator 65 includes a combined beam modifier 89 (“beam modifier 89”) and a combined beam separator 83 (“beam separator 83”) optically coupled to the beam modifier 89. The beam modifier 89 can be the same or similar to the beam modifier 15 described above. For example, the beam modifier 89 can include the reflective elements 50a and 50b. In the embodiment illustrated in FIG. 7, the reflective elements 50a and 50b can be configured to receive the combined beam 90 via an intermediary optical element 81, such as a reflective element. The beam modifier 89 can output the modified combined beam 91. The modified combined beam 91 is composed of the modified laser beams 91a and 91b. The modified laser beams 91a and 91b can be collinear between the beam modifier 89 and the beam separator 83. In various embodiments, the laser beams 13 (FIG. 6) of the combined beam 90 can be modified by adjusting the beam adjustment angle αₘ via, e.g., the beam adjustment signal S₁, as described above.

The beam separator 83 includes a first, second, and third optical elements 85a-85c. The first and second optical elements 85a and 85b can be operably coupled to beam separator components 87 (e.g., a piezoelectric device, a servo motor, etc.; shown schematically). In operation, the first optical element 85a reflects the first modified beam 91a toward the focusing optics 17 (FIG. 6), and transmits the second modified beam 91b toward the second optical element 85b. The second optical element 85b reflects the second modified beam 91b toward the third optical element 85c, which directs the second modified beam 91b back through the first optical element 85a toward the focusing optics 17. The beam separator components 87 are configured to tilt the first and second optical element 85a and 85b to angle the output laser beams 91a and 91b at a beam separator angle αₛ. In some embodiments, the beam separator components 87 can include a linkage (not shown) configured to tilt or rotate the first and second optical elements 85a and 85b based on a beam separator signal S₂ received from the controller 30 (FIG. 1) for adjusting the beam separator angle αₛ.

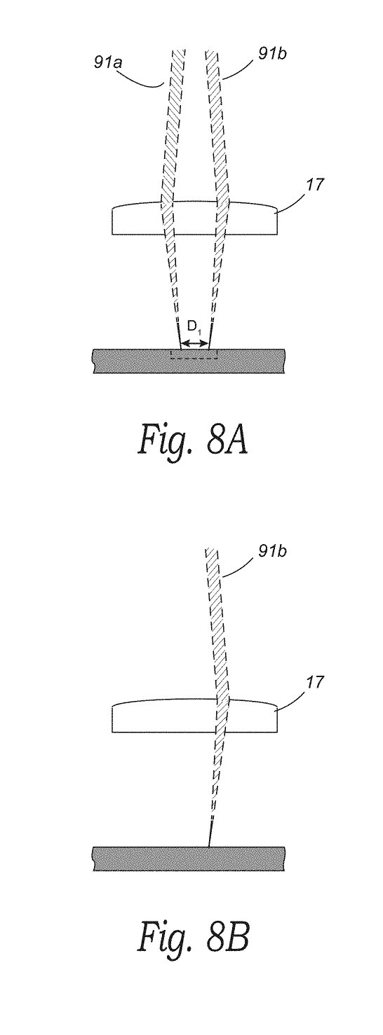

FIG. 8 is cross-sectional view showing the focusing optics 17 receiving the modified beams 91a and 91b output from the beam modifier/separator 65 (FIG. 7). The beam energy distribution of the modified beams 91 and 91b can be independently controlled, such as via the beam adjustment signal S₁ and/or the beam separator signal S₂. For example, the beam adjustment signal S₁ can be used to increase the beam adjustment angle αₘ, which, in turn, can increase the width of the individual beams 91a and 91b (e.g., in the orthogonal direction O₁) and the amount of material removed during each stroke of a raster line, as discussed above. The beam separator signal S₂ can adjust the separation angle αₛ between the modified beams 91a and 91b, causing the modified beams 91a and 91b to focus at two different positions separated by a small distance D₁. In various embodiments, increasing the separation angle αₛ can further increase throughput. For example, to reproduce 1000 dpi, the beam separator angle αₛ can be finely adjusted so that spacing between each beam when focused can be 0.001 inch, for 500 dpi the spacing the angle can be set to achieve 0.002 inch spacing at focus. Each laser can be independently controlled to transfer two lines of image information in one pass. In some embodiments, one or both of the modified laser beams 91a and 91b can be modulated. For example, the first modified beam 91a can be pulsed or turned off (as shown in FIG. 8B) at the laser source 88b, while the second modified beam 91b can be applied continuously or pulsed differently than the first modified beam 91a.

By utilizing a non-Gaussian power profile for raster applications in conjunction with two lasers separated by an angle which when focused places them side by side, the amount of material removed during a raster stroke can be further increased. In addition or alternately, the overlap between each raster stroke can be reduced due to the more uniform energy distribution provided by the non-Gaussian portion of the parallel beams. This, in turn, can creating a dramatic increase in throughput. As discussed above, there may be a trade-off between throughput and resolution of the pattern to be transferred. This tradeoff may be lessened, however, by the addition of two or more beams by a beam combiner. For example, with two beams, a 500 dpi image can be reproduced in the time it would take a single beam to produce a 250 dpi image, giving the user the speed advantage of 250 dpi resolution and the quality of 500 dpi resolution. Even with this advantage, a user may adjust one or more of the beam adjust and separator signals to selectively enhance quality or productivity.

In some embodiments, the laser processing systems described above can include a different configuration of optical elements. For example, in some embodiments, a beam combiner can include optical elements and configurations disclosed in U.S. Pat. No. 6,313,433, which is incorporated herein by reference in its entirety. In additional or alternate embodiments, the laser sources 88 (FIG. 6) can output laser beams 13 having different wavelengths, and the beam combiner 84 can be a wavelength combiner. In other embodiments, the laser beams 13 can have different polarizations, and the beam combiner 84 can be a polarization combiner.

From the foregoing, it will be appreciated that specific embodiments of the disclosure have been described herein for purposes of illustration, but that various modifications may be made without deviating from the spirit and scope of the various embodiments of the present technology. For example, although shown in the illustrated examples as employing reflective elements 50a and 50b for modifying an input laser beam, beam modifiers configured in accordance with embodiments of the present technology can include refractive elements in addition to or in lieu of reflective elements. Moreover, because many of the basic structures and functions of laser processing systems are known, they have not been shown or described in further detail to avoid unnecessarily obscuring the described embodiments. Further, while various advantages and features associated with certain embodiments of the disclosure have been described above in the context of those embodiments, other embodiments may also exhibit such advantages and/or features, and not all embodiments need necessarily exhibit such advantages and/or features to fall within the scope of the disclosure.

1-16. (canceled)

17. A laser material processing system, comprising:
multiple laser sources configured to produce corresponding laser beams each with a substantially Gaussian beam distribution;
a beam combiner configured to combine the laser beams into a combined laser beam;
combined beam positioning optics;
at least one combined beam modifier operably coupled to the combined beam positioning optics, wherein the combined beam modifier is configured to controllably modify an energy distribution of the combined laser beam for processing a material;
a combined beam separator operably coupled to the combined beam modifier, wherein the combined beam separator is configured to modulate at least one laser beam of the combined laser beam; and
focusing optics positioned to concentrate energy of the combined laser beams on or in a close proximity to the surface of the material while being processed.

18. The system of claim 17 wherein the multiple laser sources have the same wavelength.

19. The systems of claim 17 wherein the multiple laser sources have substantially different wavelengths.

20. The system of claim 17 wherein the multiple laser sources beam combiner is a polarization combiner.

21. The system of claim 17 wherein the multiple laser sources beam combiner is a wavelength combiner.

22. The system of claim 17 wherein the combined beam modifier is positioned between the beam combiner and the combined beam separator.

23. The system of claim 17 wherein the combined beam modifier is configured to controllably transform the energy distribution of individual laser beams of the combined laser beam from a substantially Gaussian beam distribution to a non-Gaussian beam distribution.

24. The system of claim 23 wherein the non-Gaussian beam distribution is substantially non-Gaussian along at least one axis of the individual laser beams.

25. The system of claim 17 wherein the combined laser beam modifier is configured to controllably transform the combined laser beam into a substantially non-Gaussian beam only in one direction to preserve a Gaussian distribution in direction perpendicular to the direction of the non-Gaussian transformation.

26. The system of claim 17 wherein the combined beam modifier is reflective.

27. The system of claim 26 wherein the combined beam modifier comprises at least two reflective surfaces positioned side by side.

28. The system of claim 26 wherein the combined beam separator is reflective.

29. The system of claim 26 wherein the focusing optics is refractive.

30. The system of claim 26 wherein the focusing optics is reflective.

31. The system of claim 17 wherein the focusing optics and the combined beam modifier are configured to controllably transform the combined beam into a substantially non-Gaussian beam in a plane other than a focal plane.

32. The system of claim 17 wherein individual laser beams of the combined laser beam are controllably modified to produce corresponding impressions on a material with a substantially uniform profile across the impressions.

33. The system of claim 32 wherein the impressions include individual lines or a portion of a plurality of raster lines.

34. The system of claim 33 wherein the individual lines are produced simultaneously.

35. The system of claim 34 wherein each laser beam of the combined laser beam is configured to be modulated independently.

36. The system of claim 34 wherein the individual lines are adjacent lines.

37. The system of claim 33 wherein the impressions include a plurality of raster lines on the material having corresponding widths, wherein the widths are maximum widths for maximizing an amount of information transfer for a given material.

38. The system of claim 37 wherein the raster lines are spaced apart from one another to transfer maximum amount of information with a minimum number of raster lines.

39. The system of claim 37 wherein the raster lines include adjacent raster lines, and wherein centers of the adjacent raster lines are spaced apart by less than a width associated with at least one of the adjacent raster lines.

40. The system of claim 34 wherein the raster lines include adjacent raster lines, and wherein centers of the adjacent raster lines are spaced apart by more than a width associated with at least one of the adjacent raster lines.
